(19) United States
(12) Patent Application Publication
(10) Pub. No.: US 2022/0187772 A1
(43) Pub. Date: Jun. 16, 2022

(54) METHOD AND DEVICE FOR THE PROBABILISTIC PREDICTION OF SENSOR DATA

(71) Applicant: IAV GMBH INGENIEURGESELLSCHAFT AUTO UND VERKEHR, Berlin (DE)

(72) Inventors: Matthias Schultalbers, Ahnsen (DE); Peter Schichtel, Heidelberg (DE); Alireza Koochali, Kaiserslautern (DE); Sheraz Ahmed, Queidersbach (DE)

(21) Appl. No.: 17/442,632

(22) PCT Filed: Mar. 10, 2020
(86) PCT No.: PCT/DE2020/100165

§ 371 Date: Sep. 24, 2021

(30) Foreign Application Priority Data
Mar. 25, 2019 (DE) 10 2019 107 612.9

(51) Int. Cl. G05B 13/02; F02D 41/00

(52) U.S. Cl. CPC G05B 13/027; F02D 41/0002

(57) ABSTRACT

The invention relates to a computer-implemented method for the probabilistic prediction of sensor data. Starting from existing time curves of a target variable and optionally from further auxiliary variables, an RCGAN according to the invention is able to calculate the probability distribution of future values of the target variable and to predict the future values of the target variable therefrom. The predicted future values of the target variable can be fed back to the technical system in which the method according to the invention is used so that the latter can adjust parameters on the basis of the obtained findings. The prediction of the filling amount of cylinders of an internal combustion engine is used here as a specific technical application.

### CROSS-REFERENCE TO PRIOR APPLICATIONS

This application is a U.S. National Phase application under 35 U.S.C. § 371 of International Application No. PCT/DE2020/100165, filed on Mar. 10, 2020, and claims benefit to German Patent Application No. DE 10 2019 107 612.9, filed on Mar. 25, 2019. The International Application was published in German on Oct. 1, 2020 as WO 2020/192827 under PCT Article 21(2).

### FIELD

The present disclosure relates to the field of the prediction of future values of a time series taking into consideration the probability distribution, using generative adversarial networks (GAN), in particular for the prediction of sensor data of a drive unit, in the application of the prediction of the filling of cylinders of an internal combustion engine.

### BACKGROUND

The prediction of future values of a given time series of characteristic variables of technical systems can positively influence the behavior of these technical systems with respect to performance, efficiency, and effectiveness. Especially in the embodiment of the prediction of the filling of cylinders of an internal combustion engine of a motor vehicle, in this way a predictive control of the entire drivetrain of the motor vehicle can take place, which results in reduced wear of the components, reduced fuel consumption, and reduced pollutant emission, while ensuring the performance at the correct power at the same time. Various methods exist for predicting future values starting from past data.

A comprehensible result can be generated easily by the method of regression to the mean, for example. Statistical models, such as ARMA (Auto Regressive-Moving Average) or ARIMA, are known for this purpose. In the field of machine learning, these include the SVM (“Support Vector Machine”), evolutionary algorithms, fuzzy logic, and artificial neural networks. Methods of regression to the mean do not take into consideration the fluctuations around the mean value, however, do not have overlap with the real value in probability distributions of complex systems, and cannot improve their result with given probability distributions.

The prediction taking into consideration probability distribution, or in other words the probabilistic prediction, of future values is based on the quantification of the variance of a prediction. Distribution estimations such as conditional quantile regression or expectile regression are known for this purpose. Furthermore, models of Bayesian probability theory are used for this purpose. With these approaches, on the one hand, there is the risk of quantile overlap and, on the other hand, they are processing intensive and require a suitable pre-distribution which has to be selected by the user.

The option results due to the use of GANs that a technical system learns unknown probability distributions from a selection of random samples from the data-generating (physical) distribution. Synthetic data are thus generated which follow the probability distribution thus learned. In this way, GANs can be trained to predict future values from a history of data. However, the assessment of whether the data resulting in this way are realistic is a potential issue. For this reason, the generation of synthetic, realistic data by means of GANs is substantially restricted to certain applications, the results of which can be intuitively assessed by a human observer, such as image, text, speech, and music data.

In German Patent Application No. DE102018200816B3, a GAN is used to generate artificial user data of a driver of a vehicle. The artificial user data are based on real user data analyzed beforehand. In the known operation of a GAN, a generator network generates artificial user data and a discriminator network discriminates between artificial and real user data, so that the generator network and the discriminator network are trained on the basis of this discrimination, and so that the generator network can be used later as an artificial user model. For this application it is sufficient to generate artificial user data which appear realistic, but which are not compared to a given probability distribution or in other words to the real values (i.e., a fundamental truth).

In C. Esteban, S. L. Hyland, G. Ratsch: “Real-valued (medical) time series generation with recurrent conditional GANs.” arXiv preprint arXiv:1706.02633, 2017, an approach for generating realistic values of medical time series using recurrent conditional GANs (RCGAN) is disclosed. The goal is the prediction of measured values for patient monitoring. On the basis of the measured values of various measured variables of the patients from a preceding period of time it is to be predicted here whether individual measured variables will exceed defined limiting values in a defined period of time in the future. RCGANs are used here, wherein the generator network and the discriminator network are each replaced by recurrent neural networks (RNN) and in particular are represented by Long Short-Term Memory (LSTM). The generator network takes a random value from a noise vector and an additional condition at each point in time at which a further future value of the time series is predicted and generates a signal value therefrom. Designations are associated with the preceding values. A synthetic time series is generated as a result due to this progressing procedure. The discriminator network receives the synthetically generated values and prepares a discrimination into synthetic or realistic for each time step and in this way attempts to learn the behavior of the time series. The discriminator network is trained here to minimize the average negative cross entropy of its predictions per time step and to minimize the designations of the values. The model is assessed by testing a model which was taught using synthetically generated values on real data or by testing a model which was taught using real data on synthetic values. In addition, reference is made to the problem that a model taught in this way could only store and play back the training data. Furthermore, the possibility is offered of being able to assess the result on the basis of the probability distribution of the output data (i.e., a fundamental truth).

Calculation methods according to German Patent Application Nos. DE19756919A1 and DE102004041708B4 are known from the prior art for determining and predicting the filling of a cylinder of an internal combustion engine.

Known methods for predicting future values of technical systems, such as sensor data of devices for controlling a drive unit, in particular the filling of the cylinders of an internal combustion engine, only depict reality with inadequate precision. Methods for probabilistic prediction of future values of a time series of sensor data are not used to control drive units, in particular of internal combustion engines, in technical systems because of deficiencies in the ability to assess their predictions with respect to realistic results.

### SUMMARY

In an embodiment, the present disclosure provides a computer-implemented method for probabilistic prediction of sensor data of a target variable of a technical system. The method includes steps for: generating a repeating conditional generative adversarial network (RCGAN); training the generated RCGAN by means of test data of the technical system; providing a time curve of the target variable; generating a historic condition time window based on the time curve of the target variable; calculating, by the trained RCGAN, a probability distribution of future values of the target variable based on the historic condition time window; predicting, by the trained RCGAN, a sensor data value of the target variable using the calculated probability distribution; and feeding the predicted sensor data value of the target variable back into the technical system.

In an embodiment, the technical system is a machine, a drive machine, an engine, or an electrical machine. In an exemplary embodiment, the method may be performed by a device comprising a drive control unit of an internal combustion engine.

An object of the present disclosure is therefore to provide a method and a device that is configured to predict future values of a time series, in particular sensor data of technical systems, in particular a drive unit, and in particular the filling of cylinders of an internal combustion engine in a probabilistic and assessable manner.

### BRIEF DESCRIPTION OF THE DRAWINGS

The embodiments of the present disclosure will be described in even greater detail below based on the exemplary figures. The disclosure is not limited to the exemplary embodiments. Other features and advantages of various embodiments of the present disclosure will become apparent by reading the following detailed description with reference to the attached drawings which illustrate the following:

FIG. 1 shows the prediction and the time curve of an exemplary sensor data value, according to some embodiments;

FIG. 2 shows a technical system for executing the method, according to some embodiments;

FIG. 3 shows a system for training the RCGAN, according to some embodiments;

FIG. 4 shows the method for training the RCGAN, according to some embodiments;

FIG. 5 shows the structure of the generator network, according to some embodiments;

FIG. 6 shows the structure of the discriminator network, according to some embodiments;

FIG. 7A shows time series from the solutions of the Lorenz equations, at various b₀, according to some embodiments;

FIG. 7B shows additional noise around the time series, according to some embodiments;

FIG. 8A shows possible future values xₜ₊₁, at various b₀, according to some embodiments;

FIG. 8B shows the entirety of the probability distribution xₜ₊₁, according to some embodiments;

FIG. 9 shows the predicted probability distribution of the exemplary data sets, according to some embodiments;

FIG. 10 shows predicted probability distributions with randomly selected condition time windows, according to some embodiments; and

FIG. 11 shows a system and method for the filling prediction of cylinders of an internal combustion engine, according to some embodiments.

### DETAILED DESCRIPTION

The present disclosure is based on the intention of teaching an RCGAN having architecture according to the embodiments disclosed herein, so that the fully trained generator network of the RCGAN is capable of predicting future values of the sensor, and so that the technical system, starting from the knowledge of the future value of the sensor, can independently take precautions to implement a desired operating principle, comprising the calculation of the future probability distribution of the target variable. In one embodiment, the technical system can be a drivetrain, a drive machine, or another type of drive unit of a vehicle and the sensor can provide a characteristic variable, which is processed by the technical system and on which further characteristic variables can be dependent. Alternatively, the technical system can in general be a machine, another drive machine or engine, or also an electrical machine which is capable of controlling technical processes. In one embodiment, the technical system can be an internal combustion engine of a vehicle and the characteristic variable of the sensor, of which the future values are to be predicted, can be a filling quantity of the individual cylinders of the internal combustion engine.

In accordance with one embodiment, the method for predicting sensor data comprises the following fundamental steps:

training an RCGAN by means of collected data of a technical system;

providing time curves of a target variable and auxiliary variables of the technical system;

generating a condition time window from the time curves of the target variable and the auxiliary variables;

calculating a future probability distribution of the target variable by way of the RCGAN;

determining a value of the target variable in the future from the calculated future probability distribution; and

feeding the predicted value of the target variable back into the technical system, so that the system can change settings using the target variable.

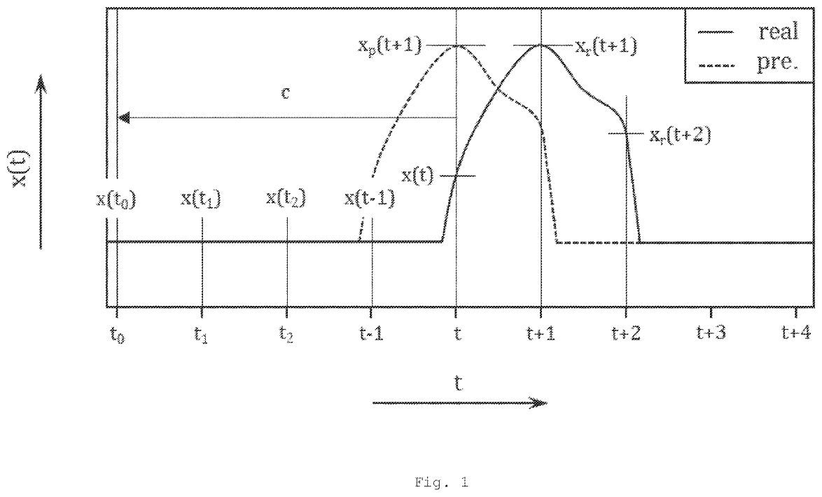

With reference to FIG. 1, the method progressively generates, at each point in time t, at which it has the value x(t) of the time series of the characteristic variable mapped by the sensor of interest, the artificially predicted future value xₚ(t+1), which is to correspond to the real future value xᵣ(t+1). Similarly thereto, in the following time step, the future value which corresponds in the present diagram to xᵣ(t+2) is predicted. For this purpose, the method takes into consideration the history of the time series of the mapped characteristic variable x(t) up to a point in time arbitrarily far in the past. By way of example, the period of time {t₀, . . . , t} is shown for this purpose in FIG. 1. The applied historic period of time can be dependent on the sampling rate of the sensor, on the measurement data recording resolution, the measurement data processing resolution, or further limiting properties of the technical system, so that the historic period of time and, in particular, the intervals between the individual time steps can be selected as desired by the user. The values associated with the observed historic period of time {t₀, . . . , t} are referred to hereinafter as the historic condition time window C={x(t₀), . . . , x(t)} or also only condition time window (C).

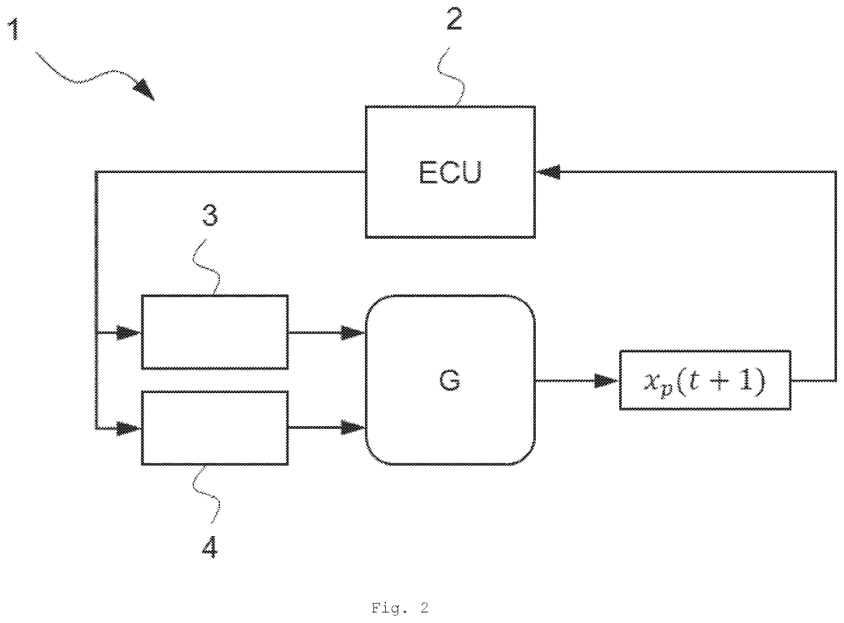

FIG. 2 shows the schematic structure of a technical system 1 for executing the method, according to some embodiments. In one embodiment, the technical system 1 comprises a drive control unit 2, a generator network G, a sensor 3 of interest, and optionally further sensors 4. The drive control unit 2 is configured to process artificially predicted future values xₚ(t+1) generated by the generator network G. The generator network G is configured to record the condition time window C of the history of the sensor data from the sensor 3 of interest and the further sensors 4 and to predict the future value xₚ(t+1) of the sensor 3 of interest therefrom. The future value xₚ(t+1) is subsequently fed back into the drive control unit 2 again, so that the drive control unit 2, starting from the knowledge about the prediction of x(t), can take precautions or adjust parameters to meet the requirements which are placed on the technical system.

In one embodiment, the drive control unit 2 is the engine control unit (ECU) of an internal combustion engine and the characteristic variable of the sensor 3 of interest is the filling quantity of the cylinders of the internal combustion engine. The filling quantity can in this case be the physical equivalent to the control stroke or a control factor fᵣ of a known lambda control, which at least indirectly represents the filling quantity in a cylinder. Alternatively, any further characteristic variable can be used that represents the filling quantity directly or indirectly. In a further embodiment, further characteristic variables are given by the sensor data of further sensors 4 by way of the drive control unit 2 or the engine control unit (ECU). The characteristic variables of the sensor data of further sensors 4 can be, for example, the engine speed (nₘₒₜ), the intake pressure, the camshaft adjustment, the throttle valve setting, lambda values, coolant temperature (Tₘₒₜ), and further characteristic variables which can negatively affect the characteristic variable of the sensor 3 of interest or are themselves influenced by this sensor. The characteristic variables of the sensor data of the further sensors 4 are summarized hereinafter under the concept of the auxiliary variables; the characteristic variable of the sensor 3 of interest is referred to as the target variable.

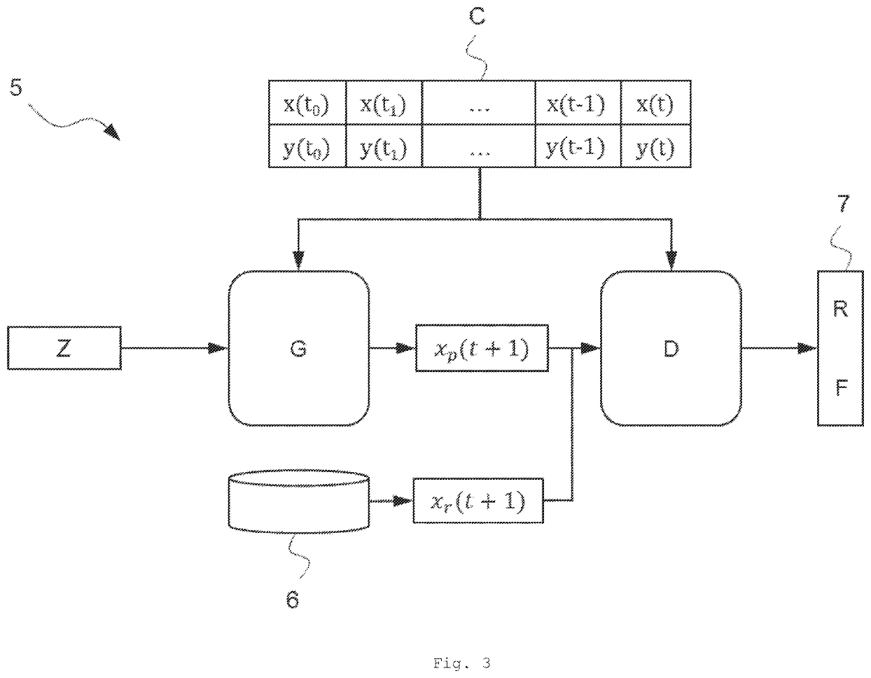

To predict a future value of the target variable, the generator network G is trained before the application. The schematic structure of a system 5 for training the RCGAN is shown in FIG. 3, according to some embodiments. The system 5 comprises the generator network G and a discriminator network D, wherein the condition time window C={x(t₀), . . . , x(t)} is used as an input variable for each of the two networks G, D. In one advantageous embodiment, both during the application and also during the training of the generator network G, the auxiliary variables S={y(t₀), . . . , y(t)} are used, wherein these are also used as input variables for the generator network G and the discriminator network D. A further input variable for the generator network G is the noise vector Z. The noise vector Z follows a known probability distribution ρ_{Rausch}(Z). In one advantageous embodiment, ρ_{Rausch}(Z) is a Gaussian normal distribution, having a mean value of 0 and a standard deviation of 1. Alternatively, any further known probability distribution can be used as the pre-distribution. During the training, the generator network G generates, from the condition time window C and the noise vector Z, artificial future values xₚ(t+1). In addition, real future values xᵣ(t+1) are taken from a training data set 6. Both the artificially generated and also the real future values xₚ(t+1), xᵣ(t+1) are used as the input variable for the discriminator network D. The discriminator network D creates for each time step, from the condition time window C and the artificially generated or real future value xₚ(t+1), xᵣ(t+1), an assessment 7, wherein it is stored therein whether the predicted future value is a correct R or incorrect F value. Correct R as used herein means that the predicted future value xₜ₊₁=xₚ(t+1)=xᵣ(t+1) follows a known probability distribution and incorrect F accordingly means that the value xₜ₊₁ does not follow this probability distribution.

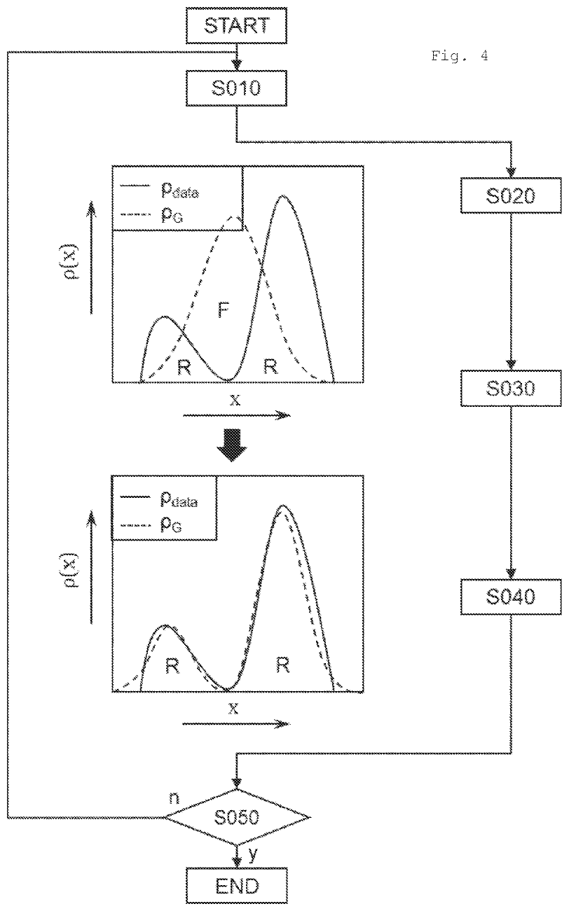

In FIG. 4, the method for training the RCGAN is shown, according to some embodiments. For each training, a known, existing data set is divided into three partial data sets. In one embodiment, 50% of the existing data set is used as a training data set, 10% as a validation data set, and 40% as a test data set 11. Alternatively, any further division of the data set is possible. A data set, as used herein, consists of multiple value pairs of the sensor data, which were generated by the technical system 1. In this way, the real behavior of the specific application of the technical system 1 can be depicted for the training of the RCGAN. Alternatively, a data set can be artificially generated, for example, by simulation of all of or parts of the technical system 1. In one training pass, in a first step S010, a part of the training data set is taken, on which, in a further step S020, the generator network G is then trained. In a further step S030, the discriminator network D is trained using a further independent part of the training data set 6. In a further step S040, the result of the training is assessed using the validation data set and it is subsequently checked whether the result meets S050 the requirements of the application in the technical system 1. If this is not the case, a further training pass takes place, beginning at the first step S010. However, if the result meets the requirements, the training is ended.

The entire data set has an unknown probability distribution ρ_{Data}(x), from which the known generator distribution ρ_{G}(x) initially deviates (FIG. 4, top). During the training, the noise vector Z is taken from the known pre-distribution ρ_{Rausch}(z). The generator network G attempts to generate a sample from the noise vector Z and the condition time window C, which follows the unknown probability distribution ρ_{Data}(x). At the same time, the discriminator network D attempts to discriminate between the artificial sample and a real sample from the training data set 6. Viewed mathematically, during the training, the value function V(G, D) is calculated according to equation 1:

$$\begin{matrix}min & max \\ G & D\end{matrix} V ( D , G ) = {𝔼}_{x \sim {ρ}_{data} ( x )} [ log D ( x ) ] + {𝔼}_{z \sim {ρ}_{Rausch} ( z )} [ log ( 1 - D ( G ( z ) ) ) ] \qquad ( 1 )$$

In other words, the generator network G, using the known probability distribution ρ_{Rausch}(Z), learns to generate a generator distribution ρ_{G}(x), which is similar to the probability distribution ρ_{Data}(x) of the training data set (FIG. 4, bottom). In one advantageous embodiment, wherein auxiliary variables are incorporated into the prediction of the target variable, the RCGAN can be conditioned to the additional items of information y(t). These can be any type of items of information, for example, class labels or further data. In one advantageous embodiment, these items of information correspond to the auxiliary variables S={y(t₀), . . . , y(t)} and are therefore characteristic variables of the technical system 1, which can be produced by further sensors 4. The auxiliary variables can be used here both by the generator network G and also the discriminator network D as an additional input variable. The value function V(G, D) according to equation 2 results here:

$$\begin{matrix}min & max \\ G & D\end{matrix} V ( D , G ) = {𝔼}_{x \sim {ρ}_{data} ( x )} [ log D ( x \vert y ) ] + {𝔼}_{z \sim {ρ}_{z} ( z )} [ log ( 1 - D ( G ( z \vert y ) ) ) ] \qquad ( 2 )$$

To now model the probability distribution of the future value xₜ₊₁, equation 2 is mapped on the condition time window C={x(t₀), . . . , x(t)}, wherein the auxiliary variables S={y(t₀), . . . , y(t)} are integrated in C, so that C={x(t₀), . . . , x(t); y(t₀), . . . , y(t)} and the value function V(G, D) is calculated according to equation 3 as follows:

$$\begin{matrix}min & max \\ G & D\end{matrix} V ( D , G ) = {𝔼}_{{x}_{t + 1} \sim {ρ}_{data} ( {x}_{t + 1} )} [ log D ( {x}_{t + 1} \vert c ) ] + {𝔼}_{z \sim {ρ}_{z} ( z )} [ log ( 1 - D ( G ( z \vert c ) ) ) ] \qquad ( 3 )$$

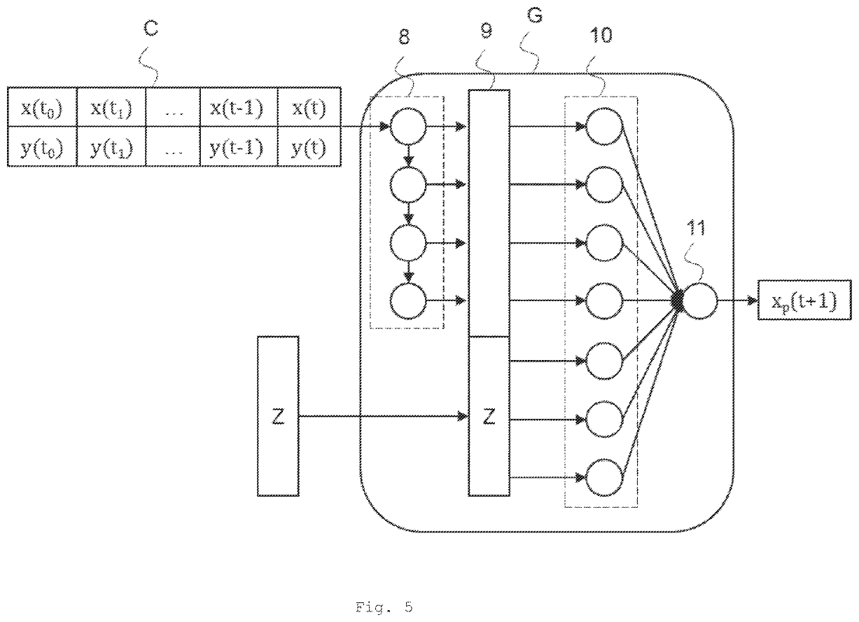

FIG. 5 shows the structure of the generator network G, according to some embodiments. The generator network G comprises a first RNN layer 8 and two dense NN layers 10, 11. The first RNN layer 8 is configured to process the condition time window C and to represent it in a state vector 9. The first dense NN layer 10 is configured to process the state vector 9 and the noise vector Z. The second dense NN layer 11 is configured to process the outputs of the first dense NN layer 10 and to generate the artificially predicted future value xₚ(t+1).

The generator network G takes the condition time window C and the noise vector Z as input variables for this purpose and feeds the condition time window C into the first RNN layer 8. The first RNN layer 8 generates the state vector 9 from the condition time window C and links it to the noise vector Z. State vector 9 and noise vector Z are fed into the first dense NN layer 10, which further processes them and feeds them into the second dense NN layer 11. For this purpose, the first RNN layer 8 comprises a defined number of cells, which is described hereinafter with the variable RG. The noise vector Z comprises a number of N random samples. Accordingly, the first dense NN layer 10 comprises a number of RG+N cells. The second dense NN layer 11 comprises only one cell.

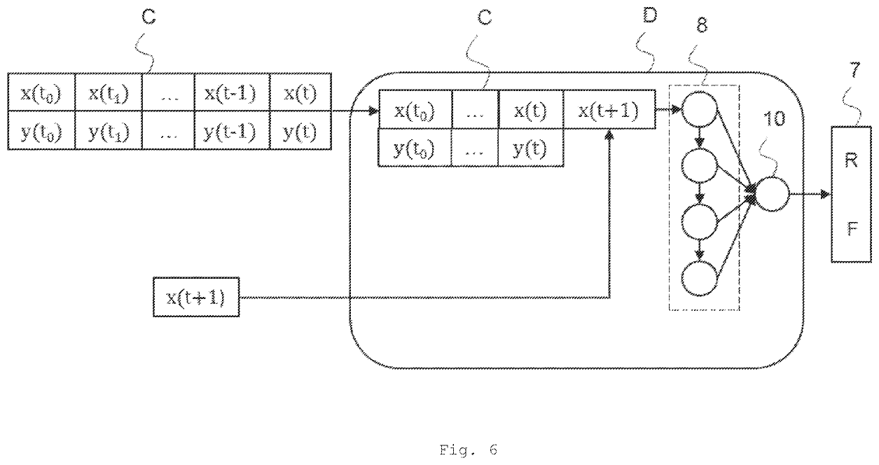

FIG. 6 shows the structure of the discriminator network D, according to some embodiments. The discriminator network D comprises a first RNN layer 8 and a dense NN layer 10. The first RNN layer 8 is configured to process the condition time window C and a future real value xᵣ(t+1) or a predicted artificial value xₚ(t+1) and to feed the results as the state vector into the dense NN layer 10. The dense NN layer 10 is configured to generate an assessment 7 from the results of the first RNN layer 8, wherein this contains an item of validity information R, F. The discriminator network D thus takes the artificial, predicted future value xₚ(t+1) of the generator network G for the value xₜ₊₁ or the real value xᵣ(t+1) from the training data set 6, links it to the condition time window C, and feeds it into the first RNN layer 8. For this purpose, the first RNN layer 8 comprises a defined number of cells, which is described hereinafter with the variable RD. The dense NN layer 10 comprises only one cell.

In one embodiment, the first RNN layers 8 of the generator network G and the discriminator network D are LSTM (“long short-term memory) or GRU (“gated recurrent unit”). The selection of this cell type is described hereinafter in the variable T. For the variables mentioned here, which are referred to hereinafter as hyperparameters, various values were compiled, which can result in different embodiments in combination. Possible values for the hyperparameters for the method are listed in Table 1. Other value and types are possible.

TABLE 1

| Designation | Variable | Values |
|---|---|---|
| cell type | T | GRU, LSTM |
| cell number of generator | RG | 1, 2, 4, 8, 16, 32, 64, 128, 256 |
| cell number of discriminator | RD | 1, 2, 4, 8, 16, 32, 64, 128, 256 |
| dimension of noise vector | Z | 1, 2, 4, 8, 16, 32 |
| dimension of the conditions | C | 1, 2, 4, 8, 16, 32, 64, 128, 256 |
| number of training iteration | Dᵢₜₑᵣ | 1, 2, 3, 4, 5, 6, 7 |
| discriminator | | |

During the training of the RCGAN during each pass of the method according to FIG. 4, the generator network G is trained once and the discriminator network D is trained multiple times. With reference to Table 1, the number of the iterations with which the discriminator network D is trained within a training pass is referred to as the variable Dᵢₜₑᵣ. All hyperparameters which are listed in Table 1 are specifically set for each application. In one advantageous embodiment of the method, the setting of the hyperparameters is carried out by a genetic algorithm. The genetic algorithm uses directed random searches to find optimum solutions in complex problems. All hyperparameters are coded here in a vector which is referred to as a gene. The algorithm begins with a series of randomly initialized genes, which form a gene pool, and attempts to find the best optimized gene by iterative progress. During each iteration, the genes in the gene pool are assessed using an adaptation function and those with low values are eliminated. The remaining genes are then used to form descendants. After multiple iterations, the algorithm converges to a gene having the best optimized value combination. In one embodiment, the algorithm has a gene pool of the size 8 and 8 iterations are carried out. During each iteration, the 4 genes having the best values are used here to generate descendants. In each case, 4 genes are generated by gene exchange and 4 further ones by mutation. Subsequently, a variant of the RCGAN is constructed using the gene generated in this way and trained using a training data set (6), wherein this is validated by means of assessment of the Kullback-Leibler divergence (KLD) by a validation data set. The KLD is defined by:

$$KLD ( P \vert Q ) = {\sum }_{i} {P}_{i} log \frac{{P}_{i}}{{Q}_{i}} \qquad ( 4 )$$

The deviation between the probability distributions P and Q is determined here, wherein P is the data distribution and Q is the distribution of the prediction probability. If therefore, because of the occurrence of Q in the denominator, the predicted distribution does not correctly depict the data distribution, the KLD is undefined.

In an alternative embodiment, to assess the RCGAN generated in this way, the known punctiform error identifiers RMSE and/or MAE and/or MAPE are used, which are defined as follows:

$$\begin{matrix}R MSE = \sqrt{\frac{1}{N} {\sum }_{i} {( {x}_{i} - )}^{2}} & ( 5 ) \\ MAE = \frac{1}{N} {\sum }_{i} \vert {x}_{i} - \vert & ( 6 ) \\ MAPE = \frac{1}{N} {\sum }_{i} \vert {10}^{2} \times \frac{{x}_{i} -}{{x}_{i}} \vert & ( 7 )\end{matrix}$$

In this case, N is the number of the data samples, xᵢ and [symbol] are the current predictions. Punctiform error identifiers as loss functions only have limited suitability, however, to judge distribution similarities. Therefore, adversarial training is advantageously applied to train the neural networks for the prediction.

In one advantageous embodiment of the method, a generator regression model is constructed which has the identical structure of the generator of the RCGAN. In this generator regression model, the error identifier RMSE is optimized as a loss function and its results are used as the comparison of the conventional methods of the data prediction by means of neural networks to the RCGAN. With reference to FIG. 4, the RCGAN trained according to the method is compared during the training, in the step of validation S040, to the trained generator regression model. To assess the respective results, the error identifiers RMSE, MAE, MAPE, and/or the KLD can be used.

In one advantageous embodiment of the method, to assess the RCGAN, 100 predictions of xₜ₊₁ for each condition are taken from a test data set and the prediction probability distribution is calculated for the entire test data set. Subsequently, the KLD is formed between the prediction probability distribution and the data distribution of the test data set. For the comparison, starting from the data of the histogram of the prediction of the generator regression model, the KLD for this model is determined. For the assessment by means of punctiform error identifiers, the prediction by the RCGAN can be applied 100 times to the test data set and a mean value and the standard deviation for the corresponding error identifiers can be calculated therefrom. Alternatively, the application of the RCGAN to the data set can take place an arbitrary number of times. The result of the KLD thus indicates how accurately the RCGAN has learned the distribution from the data set.

Depending on the area of application, different data sets can be used as the training data. In one advantageous embodiment, in which the method is applied to predict the filling of the cylinders of an internal combustion engine, a data set is used which is based on the foundation of the Lorenz equations. The Lorenz equations describe the atmospheric convection a, the horizontal temperature change b, and the vertical temperature c as a function of the time t. With a point for the time derivative, the system of the coupled differential equations is given by:

\dot{a}=σ(b−a),

\dot{b}=a(γ−c),

ċ=ba−βc (8)

wherein a is proportional to the Prandtl number, γ is proportional to the Rayleigh number, and R is linked to the physical dimensions of the atmospheric layer of interest. One of the most interesting features of the Lorenz equations is the occurrence of chaotic behavior for certain values of the parameters σ, γ, and β. In one embodiment, the parameters σ=16, γ=45.92, and β=4 are used. Alternatively, any further combination of the parameters σ, γ, and β can take place. By further definition of the starting conditions for a₀, b₀, and c₀, arbitrary time series x(t) can be developed from this system of equations. From these time series, furthermore random samples can be taken, which then depict the probability distribution of the data and can be used as the condition time window C.

Alternatively, data can be generated according to the Mackey-Glass approach, which is based on the following differential equation for the time delay:

$$\dot{x} = \frac{a x ( t - τ )}{( 1 + 10 \cdot ( t - τ )} - b x ( t ) \qquad ( 9 )$$

In one advantageous embodiment, the parameters of this differential equation are set to a=0.1, b=0.2, and τ=17 to depict chaotic behavior.

Alternatively, data can be taken from the Internet traffic data set, which contains the prediction of the Internet traffic and is also known as A5M.

Due to the individual steps, the collection of the time curves of the sensor data, the calculation of the probability distribution of the target variable by the RCGAN, the feeding of the result back into the drive control unit, and the processing of the result thereby, a time delay can occur, so that the RCGAN can also calculate values of the target variable which are farther in the future than the next immediately following time step.

### Exemplary Embodiment

Exemplary embodiments of the described embodiments are described hereinafter. These are used to illustrate the principle, wherein the method is not to be limited by the exemplary embodiments shown. Further special features and advantages additionally result from the supporting figures.

With reference to Table 2, in the following, 3 exemplary embodiments are described, wherein a special exemplary data set and a combination of hyperparameters are assigned to each of them. In a first embodiment, chaotic data distributions are generated from a Lorenz data set. With reference to equation (8), the parameters of the Lorenz equations are set to the values σ=16, γ=45.92, and β=4. To generate the data set, first 5 numeric values are selected for the starting condition b₀ and the associated relative occurrence thereof according to Table 3.

TABLE 2

| | Lorenz | Mackey-Glass | Internet traffic |
|---|---|---|---|
| Variable | data set | data set | data set |
| T | GRU | LSTM | GRU |
| RG | 8 | 64 | 8 |
| RD | 64 | 256 | 128 |
| Z | 32 | 4 | 16 |
| C | 24 | 32 | 32 |
| Dᵢₜₑᵣ | 2 | 6 | 3 |

TABLE 3

| Index | b₀ | Relative occurrence |
|---|---|---|
| 0 | 1.0001 | 5.5% |
| 1 | 1.000001 | 22% |
| 2 | 1.00000001 | 42% |
| 3 | 1.0000000001 | 24% |
| 4 | 1.000000000001 | 6.5% |

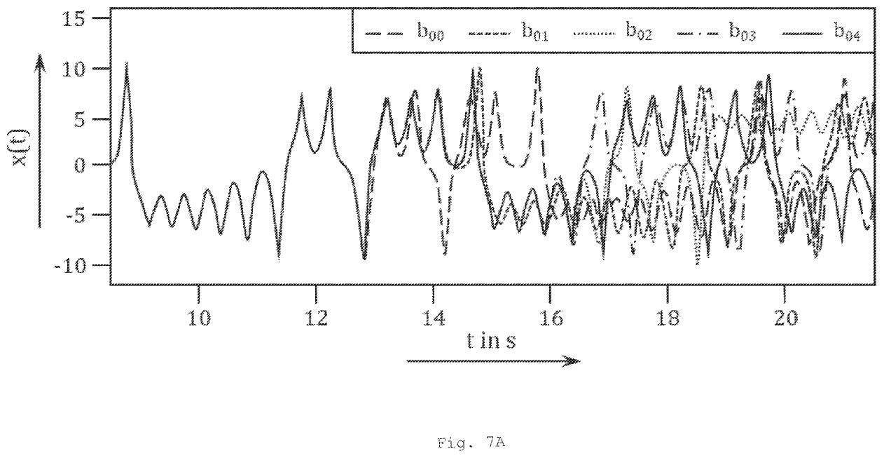

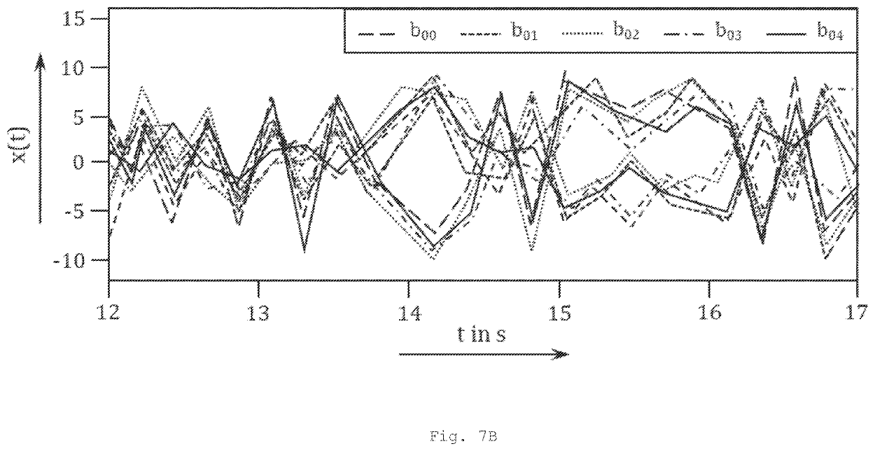

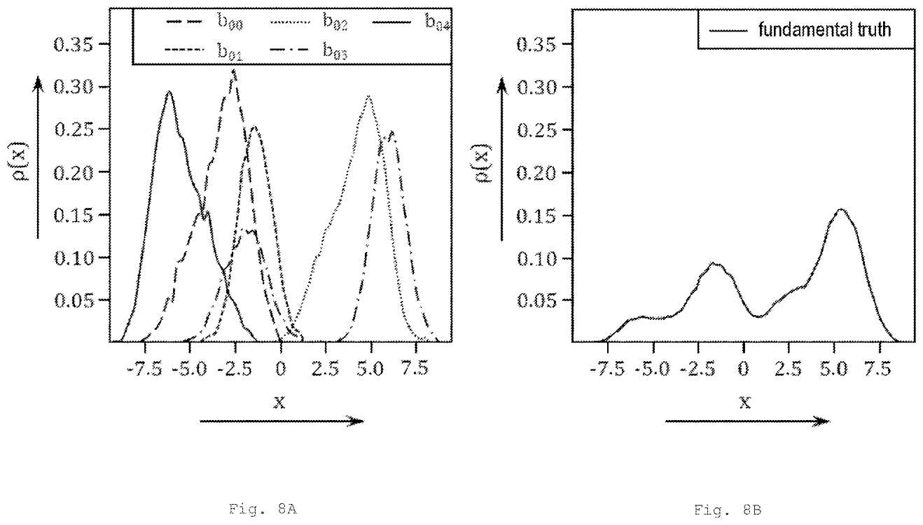

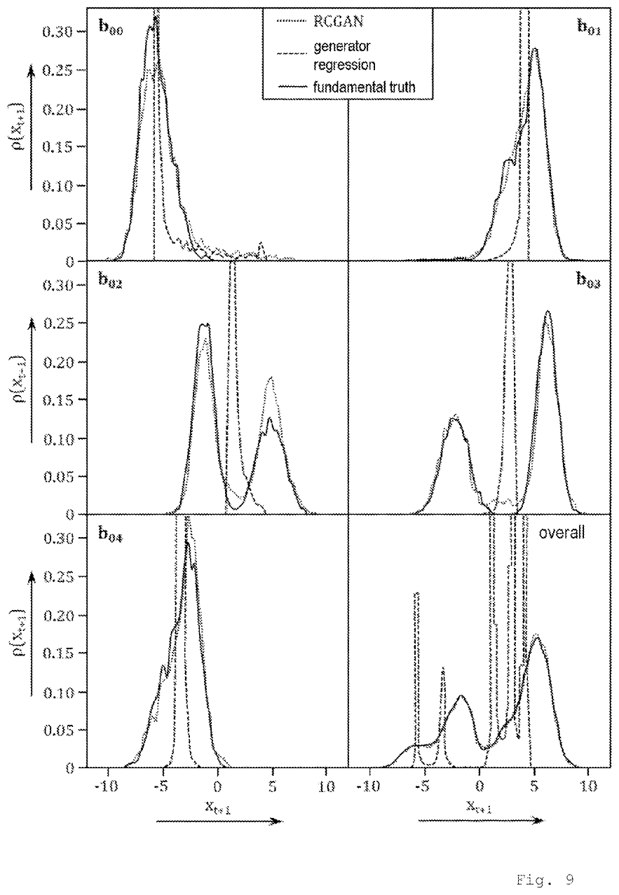

The starting conditions for a₀ and c₀ are set to a₀=1 and c₀=1. 100,000 data samples having the length of 26 s and the resolution of 0.02 s are generated. A time series thus result which are partially shown in FIG. 7A. The time series shown in FIG. 7A have a Gaussian noise having the mean value 0 and a standard deviation of 7.2 added thereto, to generate unique time windows having chaotic data series. With reference to FIG. 7B, the condition time window C is selected between seconds 12 and 17 from the data resulting in this way. The data set of the condition time window is shown in FIG. 7B. Furthermore, random samples are taken for the target variables xₜ₊₁ having the values t∈(20, 22, 25). The random samples taken form probability distributions for xₜ₊₁ for the respective starting values b₀ᵢ (i={0, . . . , 4}), which are shown in FIG. 8a. With reference to FIG. 8A, the probability distributions of the target variables xₜ₊₁ to be predicted for t∈(20, 22, 25) have different probability distributions for the different starting values b₀ᵢ (i={0, . . . , 4}). In FIG. 8B, the complete probability distribution of the selected xₜ₊₁ for the entire data set is shown.

By application of a genetic algorithm having a gene pool of the size 8 and 8 executed iterations, the hyperparameters for this embodiment are defined according to Table 2. Therefore, an RCGAN results with GRU as the cell type T, 8 generator cells RG, 64 discriminator cells RD, a noise vector Z of the length 32, a condition vector C of the length 24, with 2 iterations Dᵢₜₑᵣ of the discriminator training.

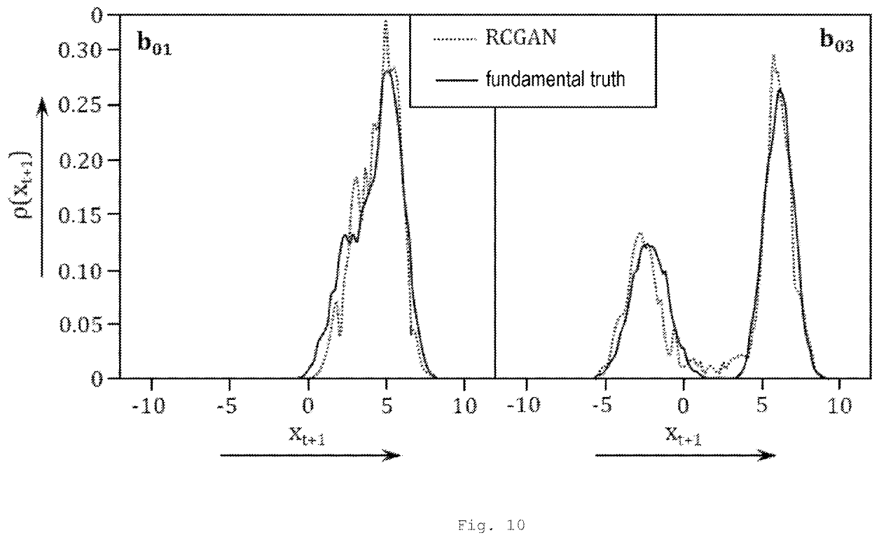

The RCGAN generated in this way is trained according to the method of FIG. 4 on the generated Lorenz data set. To assess the RCGAN generated in this way, a generator regression model having identical structure of the generator G of the RCGAN is constructed and the error identifier RMSE (equation 5) is optimized as a loss function. Subsequently, both for the RCGAN and also for the generator regression model, 100 predictions of xₜ₊₁ are carried out for the selected condition time window C. This procedure is carried out for each starting value b₀ᵢ (i={0, . . . , 4}) and for the entire Lorenz data set. In FIG. 9, the results of the predicted probability distribution of the RCGAN, the generator regression model, and the true value (i.e., fundamental truth) for the Lorenz data set are shown. Because the generator regression model cannot depict a probability distribution, the histogram of the results of the 100 passes is shown for this. It can be seen that the RCGAN depicts the true values (i.e., fundamental truth) both over the individual starting values b₀ᵢ (i={0, . . . , 4}) and also over the entire data set with a high level of correspondence, whereas the generator regression model trained in the conventional manner rather depicts the weighted mean values. According to some embodiments, the comparison to the fundamental truth advantageously represents a possibility of assessing the quality of the RCGAN developed in this way.

If the exemplary embodiment just described is applied in a similar manner to the further exemplary data sets of the Mackey data set and the Internet traffic data set, as shown in Table 2, the following results are achieved, which are shown in Table 4. With respect to the calculated error identifiers of the Lorenz data set from Table 4, the error values of the generator regression are lower than those of the RCGAN. For the application of the Mackey-Glass data set, however, the RCGAN has lower error values than the generator regression. This is of interest in particular with regard to the error identifier RMSE, since the generator regression model was optimized directly on RMSE. With respect to the Internet traffic data set, the achieved results of generator regression and the RCGAN are in balance.

TABLE 4

| | | Generator | |
|---|---|---|---|
| Data set | Assessment | regression | RCGAN |
| Lorenz data set | RMSE | 2.91 | 4.06 |
| | MAE | 2.39 | 2.94 |
| | MAPE | 2.25% | 3.35% |
| | KLD | NaN | 1.67 × 10⁻² |
| Mackey-Glass | RMSE | 5.63 × 10⁻⁴ | 3.82 × 10⁻⁴ |
| data set | MAE | 4.92 × 10⁻⁴ | 2.93 × 10⁻⁴ |
| | MAPE | 6.29 × 10⁻²% | 3.46 × 10⁻²% |
| | KLD | 8.00 × 10⁻³ | 3.18 × 10⁻³ |
| Internet-Traffic | RMSE | 1.27 × 10⁸ | 1.31 × 10⁸ |
| data set (A5M) | MAE | 9.01 × 10⁷ | 9.29 × 10⁷ |
| | MAPE | 2.85% | 2.94% |
| | KLD | 5.31 × 10⁻¹¹ | 2.84 × 10⁻¹¹ |

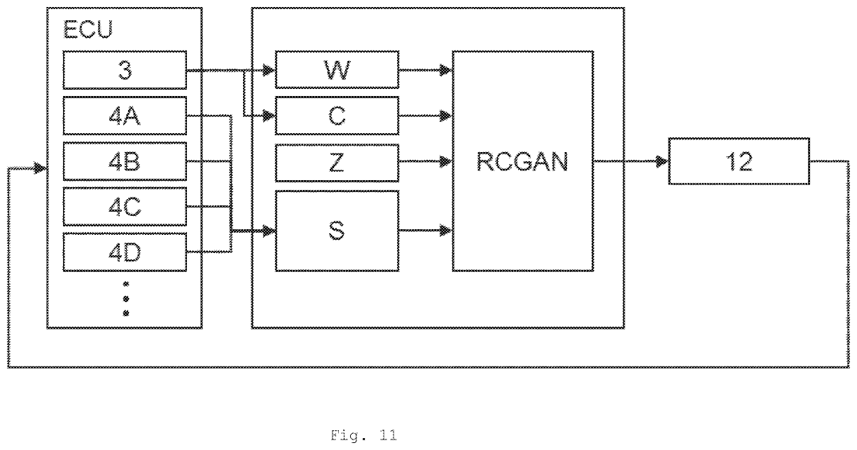

It may be derived therefrom that the RCGAN achieves comparable results for the prediction of future values from given time series as conventional prediction models, which correlate with a result of the regression to mean and additionally advantageously can depict the probability distribution of data sets with a high level of correspondence, which remains withheld from the conventional methods. To illustrate this capability, two further probability distributions are shown in FIG. 10, wherein the condition time window C was selected randomly. The test data also originate here from the Lorenz data set. It is also apparent here that the method is capable of learning the probability distribution of the given data from random samples.

If the method is applied to technical systems, for example, to the control of an internal combustion engine, it thus creates the option of teaching the probability distribution of the behavior of the internal combustion engine, on the basis of the time curves of sensory data, and thus of determining beforehand future values of the sensors with a high level of realism. In FIG. 11, a system diagram of the filling prediction of the cylinders of the internal combustion engine of a vehicle is shown for this purpose. The starting point is the engine control unit (ECU), which manages the sensor data of the internal combustion engine and of the vehicle. The management of sensor data as used herein relates to the acquisition, calculation, and further processing. For the prediction of the filling of the cylinders of the internal combustion engine, the target variable, for example, the control stroke fᵣ, is itself part of the sensor data and thus forms the sensor 3 of interest. To determine the control stroke fᵣ within the engine control unit (ECU), however, further parameters are required. Thus, the further sensor data (e.g., sensor data 4a, 4b, 4c, . . . ) are processed within the engine control unit (ECU). These data are the physical time delay, the engine speed nₘₒₜ, the relative cylinder filling rl, the camshaft adjustment, the throttle valve setting, the intake pressure, the air-fuel ratio, the coolant temperature Tₘₒₜ, the intake air temperature, and further parameters which are known for the engine control of internal combustion engines.

The target variable fᵣ contains in the engine controller further items of information about the weighting W, which are used in a known manner for the calculation within neural networks. Furthermore, the condition time window C is selected from the time curve of the sensor data of the sensor 3 of interest. The further sensor data (e.g., sensor data 4a, 4b, 4c, . . . ) are used as auxiliary variables S. For the auxiliary variables S, the history of the time curve corresponding to the condition time window is also taken into consideration, so that for a condition time window of C(fᵣ)={fᵣ(t−1), . . . , fᵣ(t₀)}, all auxiliary variables S are also represented in the form S(nₘₒₜ, Tₘₒₜ)={nₘₒₜ(t−1), . . . , nₘₒₜ (t₀); Tₘₒₜ(t−1), . . . , Tₘₒₜ (t₀); . . . }. The weighting W of the target variable fᵣ, the condition time window C, the auxiliary variables S, and the noise vector Z are now used as the input variables into the RCGAN, which was already trained beforehand, as described above. In the RCGAN, only the trained generator network G is still used, which generates from the existing input variables the probability distribution ρ(fᵣ(t+1)) of the future value of the target variable as output variable and ultimately determines a future value fᵣ(t+1) for the target variable therefrom. This is subsequently fed back into the engine control unit (ECU), which can use this information to set its parameters according to the requirements of the internal combustion engine. Due to the physical time delay because of the calculation of the probability distribution ρ(fᵣ(t+1)) of the target variable, it can be necessary for the RCGAN to calculate values for the target variable fᵣ which are further in the future than the next following time step, for example fᵣ(t>t+1).

While the embodiments disclosed herein have been illustrated in the drawings and described in detail in the foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and/or below. Additionally, statements made herein characterizing an embodiment do not necessarily refer to all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1: A computer-implemented method for probabilistic prediction of sensor data of a target variable of a technical system, the method comprising:
generating a repeating conditional generative adversarial network (RCGAN);
training the generated RCGAN by means of test data of the technical system;
providing a time curve of the target variable;
generating a historic condition time window based on the time curve of the target variable;
calculating, by the trained RCGAN, a probability distribution of future values of the target variable based on the historic condition time window;
predicting, by the trained RCGAN, a sensor data value of the target variable using the calculated probability distribution; and
feeding the predicted sensor data value of the target variable back into the technical system.

2: The computer-implemented method according to claim 1, further comprising providing time curves of auxiliary variables, wherein the historic condition time window is additionally generated based on the time curves of the auxiliary variables.

3: The computer-implemented method according to claim 1, further comprising controlling a technical process by the technical system based on the predicted sensor data value of the target variable.

4: The computer-implemented method according to claim 4, wherein the technical system is a machine, a drive machine, an engine, or an electrical machine.

5: The computer-implemented method according to claim 4, wherein the technical system is an internal combustion engine of a vehicle and the target variable is a filling quantity of cylinders of the internal combustion engine of the vehicle.

6: The computer-implemented method according to claim 5, wherein the auxiliary variables comprise at least one of: a physical time delay, an engine speed, a relative cylinder filling, a camshaft adjustment, a throttle valve setting, an intake pressure, an fuel-air ratio, a coolant temperature, or an intake air temperature.

7: The computer-implemented method according to claim 5, further comprising processing of the predicted sensor data value of the filling quantity of the cylinders, wherein the processing comprises the adjustment of at least one auxiliary variable.

8: A device configured to execute the method as according to claim 1.

9: The device according to claim 8, the device comprising a drive control unit of an internal combustion engine, wherein the drive control unit is configured to:
acquire time curves of the filling quantity and sensor data;
generate the historic condition time window from the time curves of the filling quantity and the sensor data;
calculate probability distribution of future sensor data values of the filling quantity from the historic condition time window, using the RCGAN;
determine predicted sensor data values of the filling quantity from the calculated probability distribution; and
process the predicted sensor data values of the filling quantity.

10: The drive control unit according to claim 9, wherein the processing of the predicted sensor data values of the filling quantity comprises the adjustment of at least one of auxiliary variables consisting of: engine speed, relative cylinder filling, camshaft adjustment, throttle valve setting, intake pressure, fuel-air ratio, or coolant temperature.
